(19) United States
(12) Patent Application Publication
(10) Pub. No.: US 2003/0211387 A1
(43) Pub. Date: Nov. 13, 2003

(54) Galvanic element

(75) Inventors: Eugen Braunger, Essingen (DE); Konrad Holl, Aalen-Dewangen (DE); Bernd Kreidler, Ellwangen (DE); Dejan Ilic, Ellwangen (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: VARTA Microbattery GmbH, a corporation of Germany, Am Leineufer 51,30419 Hannover, Germany

(21) Appl. No.: 10/400,990

(22) Filed: Mar. 26, 2003

(30) Foreign Application Priority Data
Mar. 27, 2002 (DE) 102 136 86.6

(51) Int. Cl. H01M 2/02; H01M 2/08

(52) U.S. Cl. 429/175; 429/174

(57) ABSTRACT

A galvanic element with an alkaline electrolyte and a zinc negative electrode, in a housing in the form of a button cell, where at least the outer surface of the cell's cap is coated with a Cu—Sn-alloy containing no nickel or with a Cu—Sn—Zn-alloy containing no nickel. The alloy contains about 20% to about 90% Cu, preferably about 50% to about 60% Cu, with the remainder being Sn, or about 50% to about 60% Cu and about 25% to about 35% Sn, with the remainder being Zn.

### RELATED APPLICATION

This application claims priority of German Patent Application No. DE 102 13 686.6, filed Mar. 27, 2002.

### FIELD OF THE INVENTION

This invention relates to a galvanic element with an alkaline electrolyte and a zinc negative electrode, in a housing in the form of a button cell.

### BACKGROUND

Galvanic elements in the form of button cells with an alkaline electrolyte generally incorporate a gel compounded from powdered zinc as their negative electrode. So-called “zinc-air cells” incorporate a gaseous-diffusion electrode as the positive electrode, or, in the case of hermetically sealed button cells, for example, manganese oxide or silver oxide, as the active compounds.

The inner surfaces of the steel or stainless steel housings of such button cells that house the zinc electrode are commonly coated with copper, while the outer surfaces of the housings have a nickel coating. Trimetallic caps of this type are disclosed in, for example, Japanese patent application JP 61061364 A1. The copper of the copper coating on the inner surfaces of the housings may be alloyed with, for example, indium, or the copper coating may be overcoated with a layer of indium to increase the hydrogen overvoltage and suppress liberation of hydrogen, in spite of the low mercury content of the zinc electrode. A special problem that occurs in the case of button cells of this type is that, over time, the alkaline electrolyte, which has a strong tendency to creep, seeps into the gap between the cap half of the housing accommodating the negative electrode and seal. If that occurs, the electrolyte also contacts the cut edge of the housing and the latter's outer surface, which is coated with nickel, and cause undesirable liberation of hydrogen. Although efforts have been devoted to preventing the alkaline electrolyte from penetrating into that area by applying adhesive compounds to the vicinities of the seals, those efforts have not led to any reproducible, reliable, results.

It would therefore be advantageous to provide a galvanic element that will further suppress the tendency toward liberating gases in the case of button cells employing alkaline electrolytes.

### SUMMARY OF THE INVENTION

This invention relates to a galvanic element including a cup, a cap sealed to the cup, the cup and cap housing an alkaline electrolyte and a zinc negative electrode, and a Cu—Sn-alloy containing substantially no nickel coated on at least an outer surface of the cap.

This invention also relates to a galvanic element with an alkaline electrolyte and a zinc negative electrode, in a housing in the form of a button cell, wherein at least the outer surface of the cap forming a portion of the housing is coated with a Cu—Sn—Zn-alloy containing no nickel.

### BRIEF DESCRIPTION OF THE DRAWINGS

The subject matter of the invention will be described in greater detail below, based on the figures in which:

FIG. 1 is a cross-section of a galvanic element in accordance with aspects of the invention; and

FIG. 2 is an exploded view of a portion of the galvanic element of FIG. 1.

### DETAILED DESCRIPTION

It will be appreciated that the following description is intended to refer to specific embodiments of the invention selected for illustration in the drawings and is not intended to define or limit the invention, other than in the appended claims.

At least the outer surface of the cap of the cell containing negative zinc-gel electrode is coated with a Cu—Sn-alloy containing substantially no nickel. It is beneficial if the same coating is also applied to the inner surface of the cap and the inner surface of the other half of the cell housing, its cup, and the outer surface thereof is also coated with that same material, if necessary.

The coating preferably includes a Cu—Sn-alloy containing about 20% to about 90% Cu and Sn, as well as Zn.

Suitable choices for the coating include, but are not limited to, alloys containing about 20% to about 60% Cu and about 40% to about 50% Sn, or alloys of about 75% to about 85% Cu and about 15% to about 25% Sn. Alloys of about 50% to about 60% Cu and about 25% to about 35% Sn, with the remainder being Zn, for example, about 15% Zn, or alloys of about 75% to about 85% Cu and about 8% to about 12% Sn, with the remainder being Zn, for example, about 5% Zn, also are preferred.

These alloys have sufficiently high hardnesses, similar to that of nickel coatings, resistance to corrosion, and low contact resistance, and have fine-grained, homogeneous, crystalline structures which have been found to be beneficial. However, they contain no nickel or substantially no nickel. “Substantially no nickel” means that nickel may only be present as an impurity in an amount insufficient to affect the characteristics of the alloy.

The wall thicknesses of the cup and cap are approximately 120 μm. The thicknesses of the coatings on their outer surfaces and on their inner surfaces, if present, range from about 0.05 μm to about 10 μm, preferably range from about 3 μm to about 6 μm.

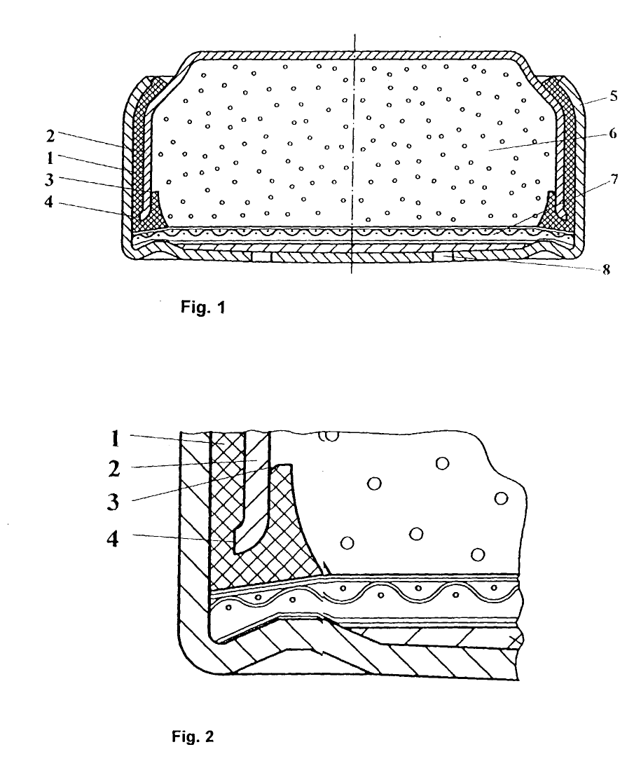

FIG. 1 depicts an alkaline button cell having a cap 2 and a cup 5. A zinc gel 6 containing alkaline electrolyte that constitutes its electronegative active compound is arranged within the cap 2, where mercury-free zinc is preferably employed. Cap 2 and cup 5 are electrically insulated from one another and the assembly hermetically sealed with respect to the ambient environment by a seal 1. A gas-diffusion electrode 7 is situated along the bottom of the cup 5. Cell cup 5 contains openings 8 that admit air. FIG. 2 depicts an enlarged sectional drawing of the cell shown in FIG. 1 for ease of understanding.

Alkaline electrolyte may seep into the vicinity of the seal during the cell's service life and, thus, reach the cut edge 4 of the cap 2 via the gap 3, and thereby come into contact with the nickel coating usually found on the cap 2, which frequently results in gas being liberated. Our investigations have shown that, compared to zinc-air batteries having conventional trimetallic caps, zinc-air batteries having caps coated with a copper-tin alloy have much lower gas-liberation rates. For example, cells of both types were stored for one month at a temperature of 60° C. and their hydrogen-liberation rates then measured and compared. Subsequent to said storage, cells according to the invention exhibited no bubbles in the vicinities of their air-admission openings 8, which were sealed by a semitransparent, adhesive foil for a better detection of bubbles possibly present.

Employment of a coating in accordance with the invention that contains substantially no nickel on at least the outer surface of the caps of button cells both largely suppresses liberation of hydrogen and provides the additional benefit that the cells have outer surfaces that contain substantially no nickel so that substantially no nickel ions that might cause allergenic reactions to occur on the skin of users will leach out of the surfaces of the housing half-shells as a result of corrosion.

1. A galvanic element comprising:
a cup,
a cap sealed to the cup,
said cup and cap housing an alkaline electrolyte and a zinc negative electrode, and
a Cu—Sn-alloy containing substantially no nickel coated on at least an outer surface of the cap.

2. The galvanic element according to claim 1, wherein the alloy contains about 20% to about 90% Cu.

3. The galvanic element according to claim 1, wherein the alloy contains about 50% to about 60% Cu, with the remainder being Sn.

4. The galvanic element according to claim 1, wherein the alloy contains about 75% to about 85% of Cu, with the remainder being Sn.

5. The galvanic element according to claim 1, wherein the outer and an inner surface of the cap are coated with the alloy.

6. The galvanic element according to claim 1, wherein inner and/or outer surface(s) of the cup are coated with the alloy.

7. The galvanic element according to claim 1, wherein the thickness of the coating is about 0.05 μm to about 10 μm.

8. A galvanic element comprising:
a cup,
a cap sealed to the cup,
said cup and cap housing an alkaline electrolyte and a zinc negative electrode, and
a Cu—Sn—Zn-alloy containing substantially no nickel coated on at least an outer surface of the cap.

9. The galvanic element according to claim 8, wherein the alloy contains about 50% to about 60% Cu and about 25% to about 35% Sn, with the remainder being Zn.

10. The galvanic element according to claim 8, wherein the alloy contains about 75% to about 85% Cu and about 8% to about 12% Sn, with the remainder being Zn.

11. The galvanic element according to claim 8, wherein the alloy contains about 20% to about 90% Cu.

12. The galvanic element according to claim 8, wherein the outer and an inner surface of the cap are coated with the alloy.

13. The galvanic element according to claim 8, wherein inner and/or outer surface(s) of the cup are coated with the alloy.

14. The galvanic element according to claim 8, wherein the thickness of the coating is about 0.05 μm to about 10 μm.
